(19) United States
(12) Patent Application Publication
(10) Pub. No.: US 2026/0169831 A1
(43) Pub. Date: Jun. 18, 2026

(54) COGNITIVE MULTI-APPLICATION USER INTERFACE MANAGER

(71) Applicant: International Business Machines Corporation, Armonk, NY (US)

(72) Inventors: Sheelagh Carew, Dundrum (IE); Richard Victor Kisley, Charlotte, NC (US); Gerald Laverte Mitchell, Durham, NC (US); Tiberiu Suto, Franklin, NY (US); Trudy L. Hewitt, Cary, NC (US)

(21) Appl. No.: 18/985,318

(22) Filed: Dec. 18, 2024

(51) Int. Cl. G06F 9/54

(52) U.S. Cl. CPC G06F 9/543

(57) ABSTRACT

Embodiments of the invention provide a computer-implemented method for controlling software applications. The computer-implemented method includes performing, using a processor system, user-initiated application operation tracking on a set of open software applications to generate user-initiated application operation tracking information. The set of open software applications include a first open software application and a second open software application. The user-initiated application operation tracking information includes inter-application operation information. The inter-application operation information includes information of a first inter-application operation associated with the first open software application and information of a second inter-application operation associated with the second open software application. A linkage between the information of the first inter-application operation and the information of the second inter-application operation is determined.

### BACKGROUND

The present invention relates in general to programmable computers operable to manage graphical user interfaces. More specifically, the present invention relates to computing systems, computer-implemented methods, and computer program products that implement a cognitively-organized and cognitively-managed multi-application user interface manager.

A user interface manager (UIM) in computer systems is a component or module that oversees the interactions between users and the computer system's graphical user interface (GUI). In software applications, the UIM facilitates the interaction between the user and application logic, often interfacing with frameworks or libraries designed for user interface (UI) development. UIMs can be used to generate and manage “tabs” of a GUI. In the context of GUIs, tabs are interface elements that allow users to navigate between different views or sections within the same application. Tabs are often used to organize content and make it easier for users to switch between related tasks without opening multiple windows.

### SUMMARY

Embodiments of the invention provide a computer-implemented method for controlling software applications. The computer-implemented method includes performing, using a processor system, tracking operations on a set of open software applications to generate user-initiated application operation tracking information. The set of open software applications include a first open software application and a second open software application. The user-initiated application operation tracking information includes inter-application operation information. The inter-application operation information includes information of a first inter-application operation associated with the first open software application. The inter-application operation information further includes information of a second inter-application operation associated with the second open software application. A linkage between the information of the first inter-application operation and the information of the second inter-application operation is determined.

Embodiments of the invention are also directed to computer systems and computer program products having substantially the same features and functionality as the computer-implemented method described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts an exemplary computing environment operable to implement aspects of the invention;

FIG. 2A depicts a non-limiting example of a system operable to implement aspects of the invention;

FIG. 2B depicts a non-limiting example of another system operable to implement aspects of the invention;

FIG. 2C depicts a table illustrating a non-limiting example of related and linked database entries generated in accordance with aspects of the invention;

FIG. 3 depicts a non-limiting example of a flow diagram illustrating a computer-implemented method embodying aspects of the invention;

FIG. 4A depicts a non-limiting example of a user interface operable to utilize aspects of the invention; and

FIG. 4B depicts a non-limiting example of a user interface operable to utilize aspects of the invention.

In the accompanying figures and following detailed description of the disclosed embodiments, the various elements illustrated in the figures are provided with three-digit reference numbers. In some instances, the leftmost digits of each reference number correspond to the figure in which its element is first illustrated.

### DETAILED DESCRIPTION

Turning now to an overview of technologies that are relevant to aspects of the invention, the term “software” refers to the set of electronic program instructions or data a computer processor reads in order to perform a task or operation. There are two main categories of software, namely systems software and application software. Systems software includes the programs that are dedicated to managing the computer itself, such as the operating system, file management utilities, and disk operating system (or DOS). Application software enables the end-user to complete tasks such as creating documents, spreadsheets, databases, and publications, doing online research, sending email, designing graphics, running businesses, and playing games. Application software can be installed locally on the end-user's computer or mobile device, or it can be stored on the cloud and accessed by any Internet-connected device. Application software is specific to the task for which it was designed and can be as simple as a calculator application or as complex as a word processing application.

A web browser, or simply a browser, is an application program specifically designed to locate, retrieve, and display content found on the World Wide Web or “web.” Each web page, image, and/or video is identified by a distinct Uniform Resource Locator (URL). A URL enables browsers to retrieve these resources from a web server and display them on the user's device. Typically, a user “browsing” the web is multi-tasking, having many web pages or images open at the same time.

As previously referenced herein, a UIM is a component or module that oversees the interactions between users and the computer system's GUI. In individual applications, the UIM facilitates the interaction between the user and application logic. UIMs can be used to generate and manage “tabs” of a GUI. Tabs are interface elements that allow users to navigate between different views or sections within the same application and/or web page. Tabs are often used to organize content and make it easier for users to switch between related tasks or categories without opening multiple windows.

Users often perform activities such as opening a software application, inputting data to the software application, clicking a link, and the like in multiple computer software applications that are open during the same work session. For example, a user working on a given project could use a computer to open a first web browser session, and the user's UIM can be configured to organize the web pages in that first web browser session into a first set of tabs. The user working on the same project could use the same computer to open a second web browser session, and the user's UIM can be configured to organize the web pages accessed in that second web browser session into a second set of tabs. The user working on the same project could use the same computer to open a first word processor application, and the user's UIM can be configured to organize the documents open in the first word processor application into a third set of tabs. The user working on the same project could use the same computer to open a first spreadsheet application, and the user's UIM can be configured to organize the documents open in the first spreadsheet application into a fourth set of tabs. The user working on the same project could use the same computer to open a first “portable document format” (PDF) application, and the user's UIM can be configured to organize the documents open in the first PDF application into a fifth set of tabs.

The user in the above example will have five (5) different software applications open and displayed during the work session. Additionally, each of the five (5) different software application will have a set of tabs open and displayed during the work session. Managing multiple different software applications and multiple sets of tabs, as well as the complex interlink of tabs and materials, can lead to confusion and inefficiency in using computer systems to complete tasks.

Accordingly, there is a need for improved user interface management technologies and techniques for users who need to manage multiple software applications and multiple sets of tabs, as well as the complex interlink of tabs and materials, in a manner that is efficient, configurable, and not confusing.

Embodiments of the invention address the above-described need by providing computing systems, computer-implemented methods, and computer program products that implement a cognitively-organized and cognitively-managed multi-application user interface manager. Embodiments of the invention perform intelligent grouping of software application content across multiple different open software applications. In embodiments of the invention, a software application is “opened” when it has been launched or started by a user. Once opened, the software application is now open. An open software application is a software application that is currently running and available for performing user-initiated application operations. The user can interact with an open software application by performing user activities such as inputting data and initiating the performance of software application operations according to the software application's design and capabilities.

In embodiments of the invention, timing information (e.g., time stamps) and cognitive algorithms are used to track user-initiated software application operations performed by the different open software applications, thereby creating multiple records of user-initiated application operations performed over time by the different open software applications. In embodiments of the invention, the timing information and cognitive algorithms are further used to correlate tracked user-initiated software applications operations to identify tracked user-initiated software application operations that are linked with one another. In embodiments of the invention, a cognitive algorithm refers to a variety of algorithm types that generate and apply computerized models to simulate the human thought process in complex situations where the answers might be ambiguous and uncertain. A cognitive algorithm includes self-learning technologies that use data mining, pattern recognition, natural language processing (NLP), and/or other related technologies to generate the mathematical models that make decisions (e.g., classifications, predictions, and the like) that, in effect, mimic human intelligence. In embodiments of the invention, the modifier “cognitive” as applied to components and functions described herein refers to components and functions that utilize cognitive algorithms to generate a result associated with the component or function. Non-limiting examples of a cognitive algorithms include artificial intelligence (AI) algorithms, NLP algorithms, natural language understanding (NLU) algorithms, language models (LMs), and similarity algorithms.

In some embodiments of the invention, the cognitive algorithms that track and link user-initiated software application operations performed by the different open software applications are incorporated within and/or utilized by the systems software. Although existing implementations of systems software enable applications to engage with aspects of the host computing system to allow the software application to perform various user-initiated application software operations (e.g., opening applications, closing applications, creating documents, spreadsheets, databases, and publications, executing online research, sending email, designing graphics, running businesses, playing games, creating presentations, and the like), such systems software does not create and keep records of user-initiated application software operations in a manner that enables such previously executed user-initiated application software operations to be analyzed and used to control other computer operations. The systems software utilized in embodiments of the invention uses the timing information (e.g., time stamps) and the cognitive algorithms to track and link user-initiated software application operations performed by the different open software applications, thereby creating multiple records of the user-initiated software application operations performed over time by the different open software applications.

In embodiments of the invention, the cognitively-organized and cognitively-managed multi-application user interface manager further uses cognitive algorithms to scan and analyze the application content of the different open software applications to generate topic information and/or category information associated with the different open software applications. The topic and/or category information can be organized based on similarity (e.g., as determined by a similarity algorithm) to further identify the open software applications and/or user-initiated software application operations that are linked based on their topic and/or category overlap. The similarity can be represented as a correlation (or relevancy) score and clustered to further identify the open software applications and/or user-initiated software application operations that are linked based on their topic and/or category overlap. The cognitively-organized and cognitively-managed multi-application user interface manager manages the matrix of analyzed application content and correlation/relevancy scores. Linked information or content sets can be created across the application content sources based on the relevancy of a particular application content source to a particular topic.

In accordance with aspects of the invention, the above-described elements of the different open software applications that have been tracked and linked can be stored and maintained in a relational database even after an open software application has been closed. The linkages between the tracked and stored elements of the different open software applications can be used to form a cognitive multi-application user interface. In embodiments of the invention, the cognitive multi-application user interface is a dynamic grouping of the different open software applications in one view that can be adjusted to present an optimum view of the open applications and linkages based on user interactions with the different open software applications. In embodiments of the invention, the linkages can be used to, where applicable, extend a user-initiated software application operation applied to one software application to the software applications that are linked to the one software application. In some embodiments of the invention, the extended user-initiated software application operation can be an “application close” software application operation. In some embodiments of the invention, the extended user-initiated software application operation can be an “application open” software application operation.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units of the systems described in this specification have been labeled as modules. Embodiments of the invention apply to a wide variety of module implementations. For example, a module can be implemented as a hardware circuit including custom VLSI circuits or gate arrays or off-the-shelf semiconductors such as logic chips, transistors, or other discrete components. A module can also be implemented in programmable hardware devices such as field programmable gate arrays, programmable array logic, programmable logic devices, or the like. Modules can also be implemented in software for execution by various types of processors. An identified module of executable code can, for instance, include one or more physical or logical blocks of computer instructions which can, for instance, be organized as an object, procedure, or function. Nevertheless, the executables of an identified module need not be physically located together but can include disparate instructions stored in different locations which, when joined logically together, function as the module and achieve the stated purpose for the module.

The components/modules of the systems illustrated herein are depicted separately for ease of illustration and explanation. In embodiments of the invention, the functions performed by the components/modules can be distributed differently than shown without departing from the scope of the various embodiments of the invention described herein unless it is specifically stated otherwise.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a cognitive multi-application user interface manager code 200. In addition to multi-application user interface manager code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and multi-application user interface manager code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

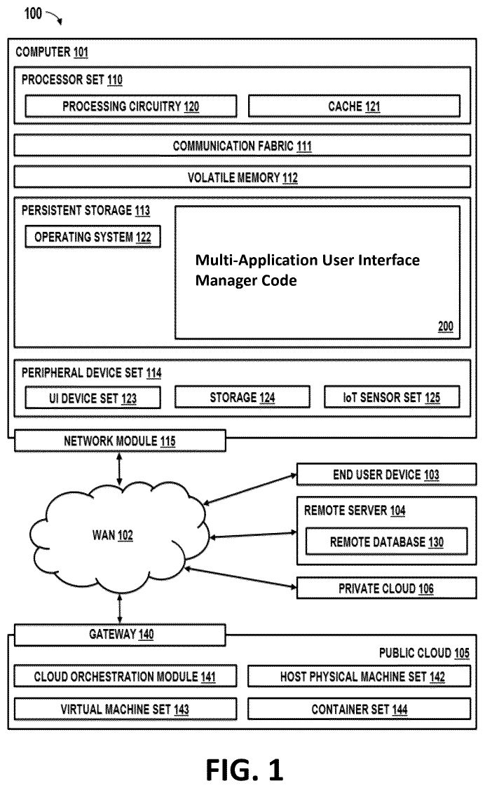

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in multi-application user interface manager code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in multi-application user interface manager code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

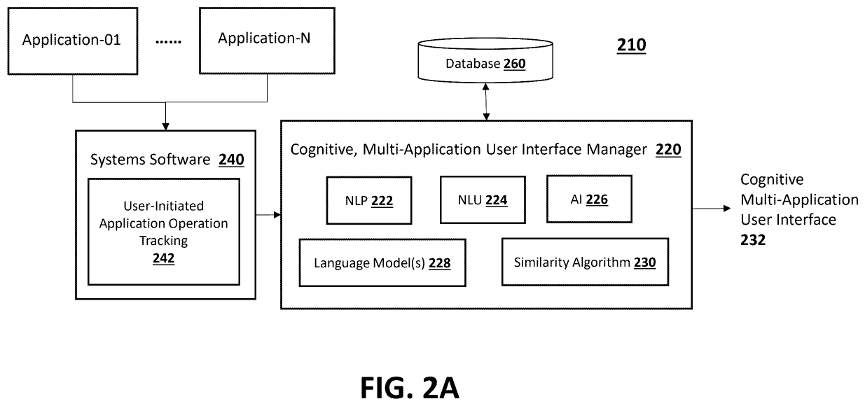

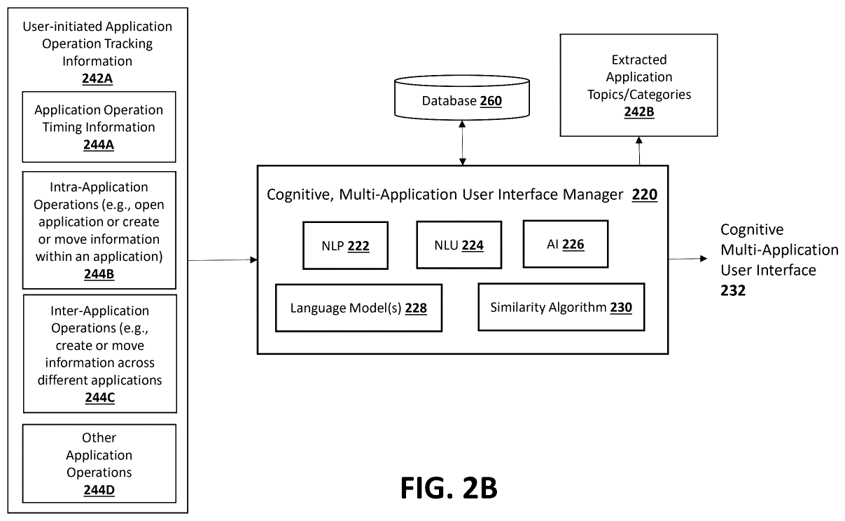

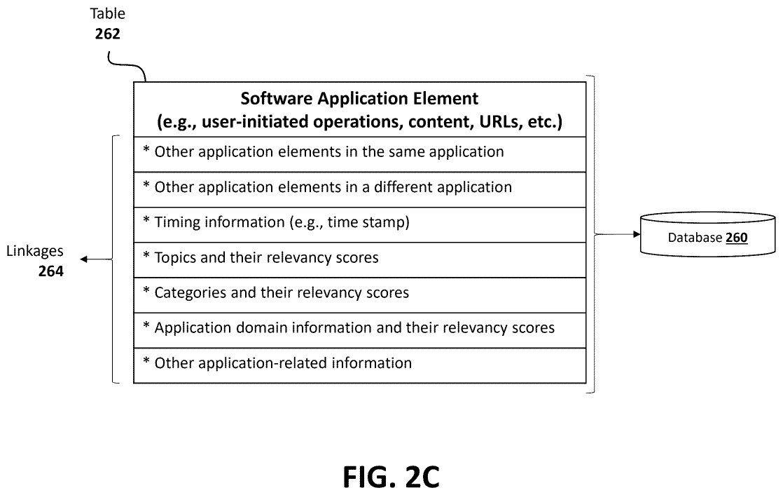

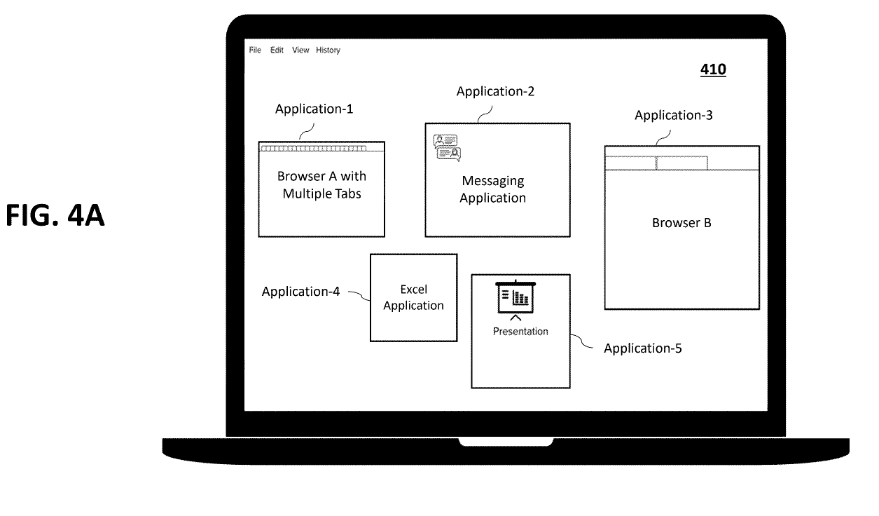

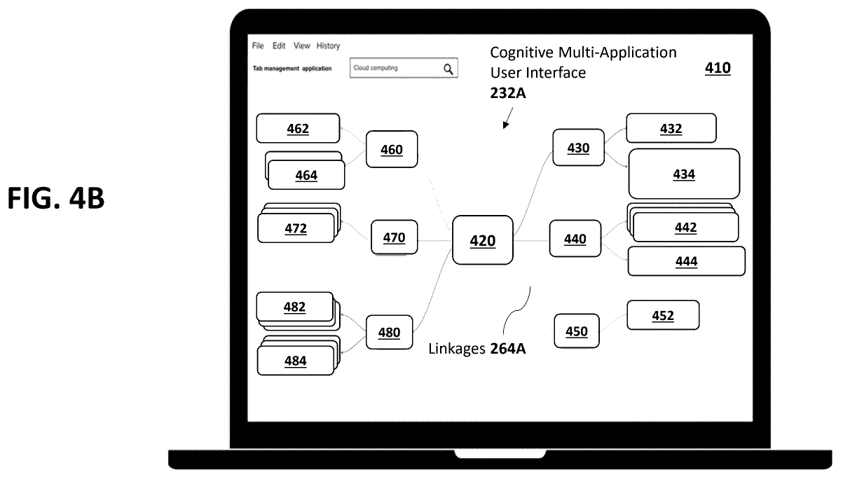

Turning now to a more detailed description of aspects of the invention, FIG. 2A depicts a non-limiting example of a system 210 embodying aspects of the invention. The system 210 can be implemented using some or all of the features and functionality of the computing environment 100 shown in FIG. 1. In embodiments of the invention, the system 210 includes systems software 240 and a cognitive multi-application user interface manager (CMA-UIM) 220, configured and arranged as shown to generate a cognitive multi-application user interface 232. A non-limiting example implementation of the cognitive multi-application user interface 232 is the cognitive multi-application user interface 232A shown in FIG. 4B and described in greater detail subsequently herein.

The systems software 240 is operable to interact with multiple software applications which are identified as Application-01 through Application-N, where N is a whole number. Applications-01 through Application-N are open and being used by a user performing one or more tasks on a computer. In embodiments of the invention, a software application is “opened” when it has been launched or started by a user. Once opened, the software application is now open. An open software application is a software application that is currently running and available for performing user-initiated application operations. The user can interact with an open software application by performing user activities such as inputting data and initiating the performance of software application operations according to the software application's design and capabilities.

A user-initiated operation performed by a software application refers to any action or command executed as a direct result of user input. The user input can be passed to the software application through a variety of mechanisms including mouse clicks, keyboard entries, voice commands, touch, gestures, and the like. Non-limiting examples of user-initiated application software operations include opening a file (e.g., a user clicks “open” in a file menu, selects a file, and the application retrieves and displays the file's contents), cutting and/or copying and pasting (e.g., a user moves information from a location in a first open software application to a location in a second open software application), saving changes (e.g., a user edits a document, then clicks “save,” and the application writes those changes to the file), submitting a form (e.g., in a web application, a user fills out a form, then clicks “submit,” and the application processes the data and sends it to a server), searching (e.g., a user types a query into a search bar, presses “enter,” and the application initiates a search operation based on that input), and changing settings (e.g., a user navigates to a settings menu and modifies the theme or notification preferences).

The term “software” refers to the set of electronic program instructions or data a computer processor reads in order to perform a task or operation. There are two main categories of software, namely, systems software and application software. The systems software 240 includes the programs that are dedicated to managing the computer itself such as the operating system, file management utilities, and disk operating system (or DOS). Systems software 240 serves as an intermediary between application software and computer hardware that manages resources, processes, memory, file systems, and I/O operations. This coordination allows software application programs to function efficiently and effectively, thereby enabling users to perform a wide range of tasks on their computers.

Application-01 through Application-N are multiple instances of software applications that enable the end-user to complete tasks such as creating documents, spreadsheets, databases, and publications, doing online research, sending email, designing graphics, running businesses, and playing games. Application software is specific to the task for which it was designed and can be as simple as a calculator application or as complex as a word processing application. Each instance of Application-01 through Application-N can be associated with a particular application domain. A “software application domain” refers to the specific area or context in which a software application operates and is designed to serve. The domain of a software application encompasses the particular problems the software application aims to solve, the target users, and the industry or field with which it is associated. Examples of software application domains include, for example, healthcare (e.g., managing patient records, scheduling, billing, and telemedicine), finance (e.g., banking, investment management, and accounting), education (e.g., learning management system (LMS) and educational tools), e-commerce (e.g., platforms for online shopping and payment processing), and gaming (e.g., application software designed for entertainment and gaming experiences).

Application software can be installed locally on an end-user's computer or mobile device, or it can be stored on the cloud and accessed by any Internet-connected device. One or more of Application-01 through Application-N can be implemented as a web browser. A web browser is a software application program specifically designed to locate, retrieve, and display content found on the web. Each web page, image, and/or video is identified by a distinct Uniform Resource Locator (URL). A URL enables browsers to retrieve these resources from a web server and display them on the user's device. Typically, a user “browsing” the web is multi-tasking, having many web pages or images open at the same time.

Although systems software enables applications to engage with aspects of the host computing system to allow the software application to perform various user-initiated application software operations, systems software does not create and keep records of user-initiated application software operations in a manner that enables such previously executed user-initiated application software operations to be analyzed and used to control other computer operations. In accordance with aspects of the invention, the systems software 240 is configured to include user-initiated application operation tracking 242. User-initiated application operation tracking 242 uses various techniques (e.g., time stamps, natural language processing (NLP), natural language understanding (NLU), artificial intelligence (AI), language models (LMs), and similarity algorithms) to create and keep records of user-initiated application software operations in a manner that enables such previously executed user-initiated application software operations to be analyzed and used to control other computer operations. In embodiments of the invention, the user-initiated application operation tracking 242 can leverage some or all of the NLP (e.g., NLP 222), NLU (e.g., NLU 224), AI (e.g., AI 226), LM (e.g., LM 228), and similarity algorithms (e.g., similarity algorithms 230) incorporated in the CMA-UIM 220 to track user-initiated application operations of Application- 01 through Application-N and store in a database 260 user-initiated application operation tracking information (e.g., user-initiated application operation tracking information 242A, 242B shown in FIG. 2B) that results from the user-initiated application operation tracking 242.

The CMA-UIM 220 is operable to perform conventional UIM functionality in in computer systems by overseeing the interactions between users and the computer system's GUI. In software applications, the UIM facilitates the interaction between the user and application logic, often interfacing with frameworks or libraries designed for user interface (UI) development. UIMs can be used to generate and manage “tabs” of a GUI. In the context of GUIs, “tabs” are interface elements that allow users to navigate between different views or sections within the same application. Tabs are often used to organize content and make it easier for users to switch between related tasks without opening multiple windows.

The CMA-UIM 220, in accordance with aspects of the disclosure, expands conventional UIM functionality by performing NLP/AI analysis on the contents of open software applications (e.g., Application-01 through Application-N) and/or user-initiated application operation tracking information (e.g., user-initiated application operation tracking information 242A (shown in FIG. 2B) generated by the systems software 240 (shown in FIG. 2A)) from multiple applications (e.g., Application-01 through Application-N) to identify user-initiated application operation tracking information sourced from one application that correlates with user-initiated application operation tracking information sourced from another application. In embodiments of the disclosure, the user-initiated application operation tracking information sourced from one application that correlates with user-initiated application operation tracking information sourced from another application are considered linked to one another. The NLP/AI analysis can be implemented using any combination of the NLP 222 and AI 226 incorporated in the CMA-UIM 220. The NLP 222 incorporates various aspects of AI (e.g., AI 226). In its simplest form, AI is a field that combines computer science and robust datasets to enable problem-solving. AI also encompasses sub-fields of machine learning and deep learning. Machine learning and deep learning are implemented as neural networks (NNs) having input layers, hidden layers, and output layers. Machine learning NNs differ from deep learning NNs in that deep learning has more hidden layers than machine learning. AI systems can be implemented as AI algorithms that seek to create expert systems operable to make predictions or classifications based on input data. In embodiments of the invention, the NLP 222 leverages model generation and pattern recognition features of the AI 226. The CMA-UIM 220 stores the above-described application content and/or user-initiated application operation tracking information in the database 260. The database 260 can be implemented as a relational database operable to store both data instances and the relationship or linkage between different data instances.

The CMA-UIM 220, in accordance with aspects of the invention, further performs NLU/LM/Similarity/AI analysis on the contents of open software applications (e.g., Application-01 through Application-N) and/or on user-initiated application operation tracking information to identify one or more topics that apply to the contents of the open software applications and/or the user-initiated application operation tracking information. User-initiated application operation tracking information may include user-initiated application operation tracking information stored and linked in the database 260. The NLU/LM/Similarity/AI analysis can be implemented using any combination of the NLU 224, AI 226, LM 228, and similarity algorithms 230 incorporated in the CMA-UIM 220. The NLP 222, NLU 224, LM 228, and similarity algorithms 230 incorporate various aspects of AI systems (e.g., AI 226). AI systems can be implemented as AI algorithms that seek to create expert systems operable to make predictions or classifications based on input data. While NLP/AI analysis focuses on what a given set of natural language (NL) information means, NLU/LM/Similarity/AI analysis provides a deeper NL analysis that identifies correlation and/or similarity between one set of NL information and another set of NL information. The NLU/LM/Similarity/AI analysis, in accordance with aspects of the invention, includes generative features that allow it to generate one or more topics that apply to the contents of the open software applications and/or the user-initiated application operation tracking information such as the user-initiated application operation tracking information stored and linked in the database 260. The NLU/LM/Similarity/AI analysis, in accordance with aspects of the invention, generates the one or more topics with a confidence level (e.g., expressed as a percentage) that the generated topic is relevant to the associated user-initiated application operation tracking information.

In aspects of the disclosure, the NLU/LM/Similarity/AI analysis can be configured to apply confidence levels (CLs) to the one or more generated topics. In some embodiments of the invention, the one or more generated topics are stored and linked to associated application content and/or user-initiated application operation tracking information in the database 260. In some embodiments of the invention, the one or more generated topics are stored and linked to application content and/or associated user-initiated application operation tracking information in the database 260 based on a threshold. For example, when the NLU/LM/Similarity/AI analysis generates a topic for which the value of CL is below a predetermined threshold (TH) (i.e., CL<TH), the topic can be classified as having sufficiently low confidence to justify a conclusion that the generated topic is not valid, and this conclusion can be used to determine when, how, and/or if the generated topic is stored, linked, and/or handled in downstream processing. If the value of CL is above a predetermined TH (i.e., CL>TH), the determination/result can be considered valid, and this conclusion can be stored with the generated topic and the application content and/or associated user-initiated application operation tracking information in the database 260. Many different predetermined TH levels can be provided. The generated topics with a CL greater than TH may be ranked from the topic with the highest CL to the topic with the lowest CL or vice versa in order to prioritize when and how the generated topics are handled in downstream processing.

In some embodiments of the invention, the NLU/LM/Similarity/AI analysis can be configured to generate relevancy scores for each of the one or more topics. The relevancy scores can be used in substantially the same manner as the above-described CLs. The NLU/LM/Similarity/AI analysis can generate top relevancy scores using any suitable relevancy score computation technique. For example, for some NLU/LM/Similarity/AI models, such as k-nearest neighbors (KNN), relevancy can be gauged using distance metrics (e.g., Euclidean distance). Closer neighbors can be considered more relevant, and their distances can be converted into relevancy scores.

The NLU/LM/Similarity/AI analysis, in accordance with aspects of the invention, can further include generative features that allow it to generate one or more categories that apply to the application content and/or user-initiated application operation tracking information, including user-initiated application operation tracking information stored and linked in the database 260. In data analysis systems, organizing data/information under a “topic” and a “category” refers to different ways of structuring and labeling information, each with its own focus and implications. Organizing data by topic focuses on overarching themes and concepts whereas organizing data by category emphasizes specific classifications and attributes. For example, “sports” is an example of a topic, and “football,” “baseball,” “basketball,” and “soccer” are examples of categories within the topic of sports. Application content and/or user-initiated application operation tracking information that includes NL text about the use of statistics to evaluate the performance of professional baseball players would have a high relevancy score for the topic of sports and the category of baseball but would have a low relevancy score for the topics of football, basketball, and hockey.

The previously-described NLP/AI analysis and the previously-described NLU/LM/Similarity/AI analysis can be implemented using any combination of the NLP 222, NLU 224, AI 226, LM 228, and similarity algorithms 230 incorporated in the CMA-UIM 220. The NLP 222, NLU 224, LM 228, and similarity algorithms 230 incorporate various aspects of AI (e.g., AI 226). In its simplest form, AI is a field that combines computer science and robust datasets to enable problem-solving. AI also encompasses sub-fields of machine learning and deep learning. Machine learning and deep learning are implemented as neural networks (NNs) having input layers, hidden layers, and output layers. Machine learning NNs differ from deep learning NNs in that deep learning has more hidden layers than machine learning. AI systems can be implemented as AI algorithms that seek to create expert systems operable to make predictions or classifications based on input data.

NLP is a branch of AI that gives machines the ability to understand natural human speech. Using linguistics, statistics, and machine learning, computers not only derive meaning from what is said or written, they can also understand some contextual nuances and a speaker's or writer's intent and sentiment in substantially the same manner as humans. NLP is a broad field that encompasses all aspects of the interaction between computers and human language. It involves the development of algorithms and systems that can analyze, interpret, and generate human language in a way that is meaningful.

NLU is a subset of NLP focused specifically on the comprehension aspect of human language. NLU involves the ability of a computer to understand the meaning and intent behind the text. NLU tasks include intent recognition (e.g., identifying what the user wants when booking a flight or asking a question), entity recognition such as identifying specific entities in the text (e.g., names, dates, locations), and context understanding (e.g., grasping context to derive meaning from phrases or sentences).

Both NLP and NLU can incorporate and leverage deep learning used in LMs. LMs can be implemented as transformer-based models that have advanced prediction and classification operations in various NL tasks such as question answering, summarization, and language (or text) generation. Because the size of some LMs can become quite large, they are often referred to as large language models (LLMs).

Similarity algorithms that analyze the similarity of NL text can leverage AI techniques and LM techniques (e.g., machine learning and deep learning) to improve their accuracy and effectiveness. By using methods like word embeddings, deep learning models, and semantic analysis, similarity algorithms can understand and evaluate text similarity in a more sophisticated manner. Similarity algorithms can use neural networks to create vector representations of words, allowing for nuanced similarity comparisons based on context and meaning.

The NL functionality of the NLP 222, NLU 224, AI 226, LM 228, and similarity algorithms 230 can incorporate transformer models that include a deep learning model that utilizes the mechanism of attention to weigh the influence of different parts of the NL input data. Like recurrent neural networks (RNNs), transformer models are designed to handle sequential data, such as NL, for tasks such as translation, text summarization, text classification, question answer, and the like. However, unlike RNNs, transformer models do not require that the sequential data be processed in order. For example, if the input data is a NL sentence, a transformer model does not need to process the beginning of the input data before processing the end of the input data. Due to this feature, transformer models allows for much more parallel computing than RNNs. Parallel computing is a type of computation where many calculations or the execution of processes are carried out simultaneously. Large problems can often be divided into smaller ones which can then be solved at the same time. In the context of training, parallel computing features of transformers enable a reduction in training times for transformer models to be achieved in comparison to the required training times for pre-transformer RNN models such as the long short-term memory (LSTM).

NNs used to implement aspects of the invention are a specific category of machines that can mimic human cognitive skills. In general, a NN is a network of artificial neurons or nodes inspired by the biological neural networks of the human brain. The artificial neurons/nodes of a NN are organized in layers and typically include input layers, hidden layers, and output layers. Machine learning differs from deep learning in that deep learning has more hidden layers than machine learning. Neuromorphic and synaptronic systems, which are also referred to as artificial neural networks (ANNs), are computational systems that permit electronic systems to essentially function in a manner analogous to that of biological brains. Neuromorphic and synaptronic systems do not generally utilize the traditional digital model of manipulating zeros (0s) and ones (1s). Instead, neuromorphic and synaptronic systems create connections between processing elements that are roughly functionally equivalent to neurons of a biological brain. Neuromorphic and synaptronic systems can be implemented using various electronic circuits that are modeled on biological neurons.

The database 260 can be implemented as a relational database. A suitable relational database that can be used in connection with embodiments of the invention is any relational database configured to provide a means of storing related information (e.g., application content, user-initiated application operation tracking information 242A, and/or extracted application topics/categories 242B as shown in FIG. 2B) in such a way that the information and the relationships between the information can be retrieved from it. The data in a relational database can be related according to common keys or concepts, and the ability to retrieve related data from a table is the basis for the term relational database. A relational database management system (RDBMS) of the computing environment 100 performs the tasks of determining the way data and other information are stored, maintained, and retrieved from the relational database 260. In accordance with aspects of the invention, the related information stored in the database 260 even after an application associated with the related information has been closed by the user. If the closed application is subsequently reopened, aspects of the invention can determine that the reopened application was previously open, determine that he reopened application has linked information stored in the database 260, and provide a user with option of reopening both the application and its linked information.

In some aspects of the invention, some or all of the NL processing, understanding, and similarity functions of the CMA-UIM 220 can be implemented using a robust expression-based cognitive data analysis technology. Some of this technology may be expression-based cognitive data analysis technology that processes information more like a human than a computer through understanding natural language, generating hypotheses based on evidence, and learning as it goes. Additionally, expression-based cognitive computer analysis provides superior computing power to keyword-based computer analysis for a number of reasons, including the more flexible searching capabilities of “word patterns” over “keywords” and the very large amount of data that may be processed by expression-based cognitive data analysis.

FIG. 2B depicts the CMA-UIM 220 (also shown in FIG. 2A) with additional details of the information generated by the systems software 240 and the user-initiated application operation tracking 242. The information generated by the systems software 240 and the user-initiated application operation tracking 242 includes user-initiated application operation tracking information 242A. The user-initiated application operation tracking information 242A includes application operation timing information 244A, which is a detection and recording of a time associated with a given user-initiated application operation. In some embodiments of the invention, the timing information can be a time stamp. In general, a time stamp is a recorded indication of the exact time at which a specific event or action occurs within a system. For example, where a user performs a cut and paste operation that moves a paragraph of text from a word processor application to a spreadsheet application, the cut operation would be assigned a time stamp, and the paste operation would be assigned a time stamp. Additionally, the relationship (or linkage) between the word processor application, the cut operation time stamp, the paragraph of text, the paste operation time stamp, and the spreadsheet application would be captured by the systems software 240 and the CMA-UIM 220 and stored in the database 260 (e.g., a relational database).

The user-initiated application operation tracking information 242A can further include intra-application operations 244B; intra-application operations 244B are operations (e.g., open the application, create information, move information, and the like) that are performed within an application. The user-initiated application operation tracking information 242A can further include inter-application operations 244C; inter-application operations 244C are operations that are performed between two or more applications (e.g., create or move information across different applications). The user-initiated application operation tracking information 242A can further include other application operations 244D that are user-initiated applications operations that do not fall within the intra-application operation 244B or the inter-application operation 244C.

FIG. 2B also depicts the CMA-UIM 220 with the additional details of the information generated by the CMA-UIM 220. The information generated by the CMA-UIM 220 includes extracted application topics/categories 242B. The CMA-UIM 220 scans application content and/or the user-initiated application operation tracking information 242A associated with the application to identify therefrom one or more topics and one or more categories associated therewith. The application content of an open software application refers to the specific data, elements, or information displayed and interacted with by the user inside the application's main interface. Non-limiting examples of application content include document or media content (e.g., in a word processor application or a media player), workspace elements (e.g., in a design or creative software application, any visual elements, layers, and tools on the canvas or artboard), user data (e.g., in a messaging application, the chats, messages, and media exchanged between users), and dashboard or view data (e.g., in business applications or analytics tools, charts, tables, or metrics displayed as part of the data or dashboard view). Accordingly, application content includes what a user directly works with, views, or modifies while the application is performing its core functionality.

The above-described software application scan operations can be performed through a combination of direct text extraction from structured formats, optical character recognition for images, NLP for analysis, and search indexing for efficient retrieval. The CMA-UIM 220 is configured to use cognitive algorithms to analyze the scanned application content of different open software applications and/or the user-initiated application operation tracking information 242A to generate topic information and/or category information associated with the different open software applications. The topic and/or category information can be organized based on similarity (e.g., as determined by a similarity algorithm 230) to further identify the open software applications and/or user-initiated software application operations that are linked. The similarity can be represented as a correlation or relevancy score and clustered to further identify the open software applications and/or user-initiated software application operations that are linked. The CMA-UIM 220 manages the matrix of analyzed application content themes and correlation/relevancy scores. Linked information or content sets can be created across the application content sources based on the relevancy of a particular application content source to a particular topic.

FIG. 2C depicts a table 262 illustrating a non-limiting example of related database entries which are generated using the systems software 240 and the CMA-UIM 220, linked together (e.g., linkages 264), and stored in the database 260 (e.g., a relational database). The top line of the table 262 is a software application element. The software application element represents any one of a variety of software application elements tracked and/or generated by the system 210 including user-initiated application operations, application content, URLs, and the like. The remaining lines or rows of the table 262 are types of application-related items that have been linked (e.g., the linkages 264) to the software application element using the operations performed by the systems software 240 and/or the CMA-UIM 220. The types of application-related items include other application elements in the same application, other applications in a different application, timing information (e.g., timestamps), topics and their relevancy scores, categories and their relevancy scores, application domain information and their relevancy scores, and other application-related information.

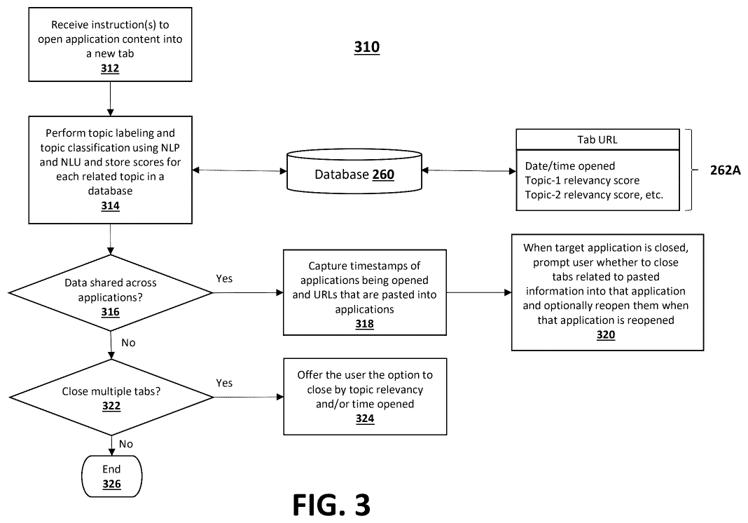

FIG. 3 depicts a non-limiting example of a method 310 in accordance with aspects of the disclosure. The method 310 can be implemented by the system 210 shown in FIG. 2A. The method 310 focuses on an example implementation of embodiments of the invention where an application is open into a new tab of a GUI. The method 310 begins at block 312 where the system 210 receives instructions to open content into a new tab of a GUI. The method 310 proceeds to block 314.

At block 314, the system 210 scans and extracts application content from the application and topic labelling and topic classification of the tab and application content using NLP (e.g., NLP 222) and NLU (e.g., NLU 224). Each related topic will be assigned a score according to its relevancy compared to the overall page content. The system 210 has category definitions and calculates a category alignment score for the content against those definitions. The categories can be extracted from a set of content based on having main keywords in common. If a tab and/or file contains multiple topics, then the method 310 uses a relevancy score cut-off or threshold (e.g., about 80%) for determining that the tab content is related to a topic (e.g., the topic of cloud computing).

The information generated at block 314 is stored in the database 260 as a linked or related set of database entries 264A. The metadata related to the tab and application content captured and stored by the method 310 can include the date and time timestamp when tab and/or application was opened and the date and time timestamps of when the tab/application is being interacted with (e.g., brought into focus, viewed, and/or scrolled through). The total time of user interaction with a tab can be calculated from this data as well. In some embodiments, with user permission, webcam data can be used to determine when a page is being viewed actively.

At decision block 316, the method 310 evaluates whether or not data is being shared across applications. If the answer to the inquiry at decision block 316 is yes, the method 310 moves to block 318 to capture timestamps of applications being opened and URLs that are pasted into applications. From block 318, the method 310 moves to block 320. At block 320, when a target application is closed, the method 310 includes prompting a user for a decision on whether the user wants to close tabs that are related to pasted information into the application that is being closed. In some embodiments, the method 310 may include prompting the user about whether to reopen the same related tabs the if or when the target application is reopened.

If the answer to the inquiry at decision block 316 is no, the method 310 moves to decision block 322 to evaluate whether or not to close multiple tabs. If the answer to the inquiry at decision block 322 is yes, the method 310 offers the user the option to close the tabs and/or applications by, for example, topic relevancy and/or time opened. If the answer to the inquiry at decision block 322 is no, the method 310 moves to block 326 and ends.

FIG. 4A depicts a computer display 410 having five (5) applications open and displayed. The open applications are Application-1, Application-2, Application-3, Application-4, and Application-5; these open applications correspond to Application-1 through Application-N shown in FIG. 1 where N=5. Application-1 is a first browser session with multiple web sites open; the web sites are organized by the first browser session under a set of tabs. Application-3 is a second browser session with multiple web sites open; the web sites are organized by the second browser session under a set of tabs.

FIG. 4B depicts the computer display 410 after the system (e.g., system 210 of FIG. 2A) has applied the operations disclosed herein to Application-1, Application-2, Application-3, Application-4, and Application-5 to generate a cognitive multi-application user interface 232A having graphical representations of linkages 264A. The cognitive multi-application user interface 232A is an example implementation of the cognitive multi-application user interface 232 as shown in FIG. 1. The linkages 264A are an example graphical representation of the linkages 264 as shown in FIG. 2C.

In accordance with aspects of the disclosure, the cognitive multi-application user interface 232A is a dynamic UI grouping of all of the applications (e.g., Application-1 including the Application-1 tabs, Application-2, Application-3 including the Application-3 tabs, Application-4, and Application-5) in one view that can be adjusted by the system (e.g., system 210 of FIG. 2A) to automatically or under user direction present an optimum view of the applications and linkages based on changes to the applications.

Using the system (e.g., system 210 of FIG. 2A), it is determined that one application 420 is a central application based on its user-initiated application operations and the relevance of its linkage with multiple first-level applications, namely, application 430, application 440, application 450, application 460, application 470, and application 480. Accordingly, the cognitive multi-application user interface 232A places application 420 near the center of the display 410 and shows each of the related applications and their linkages to application 420. Application 430, application 440, application 450, application 460, application 470, and application 480 may be referred to as first-level applications because they are directly linked to the central application.

The cognitive multi-application user interface 232A also displays the second-level applications based on their user-initiated interactions and linkages to the first level applications. Second-level applications are so called because they are linked to the central application via a first-level application. The second-level applications include application 432, application 434, application 442, application 444, application 452, application 462, application 464, application 472, application 482, and application 444. Again, the first-level applications include application 430, application 440, application 450, application 460, application 470 and application 480.

As shown, application 430 is a first-level application linked to second-level applications application 432 and application 434. Application 440 is a first-level application linked to second-level applications application 442 and application 444; application 442 has multiple instances. Application 450 is a first-level application linked to one second-level application, application 452. Application 460 is a first-level application linked to second-level applications application 462 and application 464; application 464 has multiple instances. Application 470 is a first-level application linked to one second-level application, application 472. Application 480 is a first-level application linked to second-level applications application 482 and application 484; both application 482 and application 484 have multiple instances.

In accordance with aspects of the disclosure, as user-initiated application operations are applied, the system (e.g., system 210 as shown in FIG. 2A) can change the relevance of the linkages between applications and application content. The system can periodically update the relevance of the linkages and adjust the configuration of the cognitive multi-application user interface 232A accordingly. In some embodiments of the invention, the system can update the relevance of the linkages and adjust the configuration of the cognitive multi-application user interface 232A responsive to the user-initiated application operations exceeding a threshold. In some embodiments of the invention, the configuration of the cognitive multi-application user interface 232A is user-selected from templates, created through modifications to the templates, or generated from the ground up with guidance from the system.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The terminology used herein is for the purpose of describing particular embodiments of the invention only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains,” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration.” Any embodiment or design described herein as “exemplary” is not necessarily to be construed as preferred or advantageous over other embodiments or designs. The terms “at least one” and “one or more” are understood to include any integer number greater than or equal to one, e.g., one, two, three, four, etc. The terms “a plurality” are understood to include any integer number greater than or equal to two, e.g., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8%, 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

It will be understood that those skilled in the art, both now and in the future, may make various improvements and enhancements which fall within the scope of the claims which follow.

What is claimed is:

1. A computer-implemented method for controlling software applications, the computer-implemented method comprising:
performing, using a processor system, user-initiated application operation tracking operations on a set of open software applications to generate user-initiated application operation tracking information;
wherein the set of open software applications comprise a first open software application and a second open software application;
wherein the user-initiated application operation tracking information comprises inter-application operation information; and
wherein the inter-application operation information comprises:
information of a first inter-application operation associated with the first open software application; and
information of a second inter-application operation associated with the second open software application; and
determining, using the processor system, a linkage between the information of the first inter-application operation and the information of the second inter-application operation.

2. The computer-implemented method of claim 1, wherein determining, using the processor system, the linkage between the information of the first inter-application operation and the information of the second inter-application operation comprises:
electronically scanning, using the processor system, application content of the first open software application to determine a topic associated with the first open software application; and
electronically scanning, using the processor system, application content of the second open software application to determine a topic associated with the second open software application;
wherein determining the linkage between the information of the first inter-application operation and the information of the second inter-application operation is based at least in part on a result of a comparison of the topic associated with the first open software application with the topic associated with the second open software application.

3. The computer-implemented method of claim 2 further comprising using a similarity algorithm to perform the comparison of the topic associated with the first open software application with the topic associated with the second open software application.

4. The computer-implemented method of claim 1, wherein the user-initiated application operation tracking comprises associating a time stamp with user-initiated application operations applied to the set of open software applications.

5. The computer-implemented method of claim 1, wherein the linkage between the information of the first inter-application operation and the information of the second inter-application operation is stored in a relational database.

6. The computer-implemented method of claim 1 further comprising generating, using the processor system, a graphical user interface (GUI) layout based at least in part on the linkage between the information of the first inter-application operation and the information of the second inter-application operation.

7. The computer-implemented method of claim 1, wherein:
the processor system is operable to execute systems software;
the systems software performs the user-initiated application operation tracking on the set of open software applications
the first open software application comprises a web browser;
the second open software application is selected from the group consisting of a spreadsheet application, a word processor application, a portable document format application, an image-processing application, and a slide presentation application; and
the processor system is configured to, responsive to performing a first type of user-initiated software application operation on the first inter-application operation, performing the first type of user-initiated software application operation on the second inter-application operation.

8. A computer system comprising a processor system and a memory electronically coupled to the processor system, wherein the processor system is operable to perform processor system operations comprising:
performing user-initiated application operation tracking on a set of open software applications to generate user-initiated application operation tracking information;
wherein the set of open software applications comprise a first open software application and a second open software application;
wherein the user-initiated application operation tracking information comprises inter-application operation information;
wherein the inter-application operation information comprises:
information of a first inter-application operation associated with the first open software application; and
information of a second inter-application operation associated with the second open software application;
determining a linkage between the information of the first inter-application operation and the information of the second inter-application operation; and
responsive to performing an operation on the first inter-application operation, performing the operation on the second inter-application operation.

9. The computer system of claim 8, wherein determining the linkage between the information of the first inter-application operation and the information of the second inter-application operation comprises:
electronically scanning application content of the first open software application to determine a topic associated with the first open software application; and
electronically scanning application content of the second open software application to determine a topic associated with the second open software application;
wherein determining the linkage between the information of the first inter-application operation and the information of the second inter-application operation is based at least in part on a result of a comparison of the topic associated with the first open software application with the topic associated with the second open software application.

10. The computer system of claim 9 further comprising using a similarity algorithm to perform the comparison of the topic associated with the first open software application with the topic associated with the second open software application.

11. The computer system of claim 8, wherein the tracking operations comprise associating a time stamp with user-initiated application operations applied to the set of open software applications.

12. The computer system of claim 8, wherein the linkage between the information of the first inter-application operation and the information of the second inter-application operation is stored in a relational database.

13. The computer system of claim 8, wherein the processor system operations further comprise generating a graphical user interface (GUI) layout based at least in part on the linkage between the information of the first inter-application operation and the information of the second inter-application operation.

14. The computer system of claim 8, wherein:
the processor system is operable to execute systems software;
the systems software performs the user-initiated application operation tracking on the set of open software applications;
the first open software application comprises a web browser;
the second open software application is selected from the group consisting of a spread sheet application, a word processor application, a portable document format application, an image-processing application, and a slide presentation application; and
the processor system operations further comprises, responsive to performing a first type of user-initiated software application operation on the first inter-application operation, performing the first type of user-initiated software application operation on the second inter-application operation.

15. A computer program product comprising a computer readable storage medium storing program instructions operable to instruct a processor system to perform processor system operations comprising:
performing user-initiated application operation tracking on a set of open software applications to generate user-initiated application operation tracking information;
wherein the set of open software applications comprise a first open software application and a second open software application;
wherein the user-initiated application operation tracking information comprises inter-application operation information;
wherein the inter-application operation information comprises:
information of a first inter-application operation associated with the first open software application; and
information of a second inter-application operation associated with the second open software application;
determining a linkage between the information of the first inter-application operation and the information of the second inter-application operation; and
responsive to performing an operation on the first inter-application operation, performing the operation on the second inter-application operation.

16. The computer program product of claim 15, wherein determining the linkage between the information of the first inter-application operation and the information of the second inter-application operation comprises:
electronically scanning application content of the first open software application to determine a topic associated with the first open software application; and
electronically scanning application content of the second open software application to determine a topic associated with the second open software application;
wherein determining the linkage between the information of the first inter-application operation and the information of the second inter-application operation is based at least in part on a result of a comparison of the topic associated with the first open software application with the topic associated with the second open software application.

17. The computer program product of claim 16, wherein the processor system operations further comprise using a similarity algorithm to perform the comparison of the topic associated with the first open software application with the topic associated with the second open software application.

18. The computer program product of claim 15, wherein:
the tracking operations comprise associating a time stamp with user-initiated application operations applied to the set of open software applications; and
the linkage between the information of the first inter-application operation and the information of the second inter-application operation is stored in a relational database.

19. The computer program product of claim 15, wherein the processor system operations further comprise generating a graphical user interface (GUI) layout based at least in part on the linkage between the information of the first inter-application operation and the information of the second inter-application operation.

20. The computer program product of claim 15, wherein:
the processor system is operable to execute systems software;
the systems software performs the user-initiated application operation tracking on the set of open software applications;
the first open software application comprises a web browser;
the second open software application is selected from the group consisting of a spread sheet application, a word processor application, a portable document format application, an image-processing application, and a slide presentation application; and
the processor system operations further comprise, responsive to performing a first type of user-initiated software application operation on the first inter-application operation, performing the first type of user-initiated software application operation on the second inter-application operation.
